(19) United States
(12) Patent Application Publication
(10) Pub. No.: US 2026/0216590 A1
(43) Pub. Date: Jul. 30, 2026

(54) SANDBAG THROWING DEVICE

(71) Applicant: Tri-Great International LTD., Taipei City (TW)

(72) Inventor: Chunfang LUO, Taipei City (TW)

(21) Appl. No.: 19/171,699

(22) Filed: Apr. 7, 2025

(30) Foreign Application Priority Data
Jan. 26, 2025 (CN) 202520175258.9

(51) Int. Cl. A63F 11/00; G09G 3/14; H04W 56/00

(52) U.S. Cl. CPC A63F 11/0051; G09G 3/14; H04W 56/001; G09G 2320/0247; G09G 2330/08

(57) ABSTRACT

Provided is a sandbag throwing device. The sandbag throwing device includes: a throwing board provided with a throwing hole; a counter, a display screen and a light-emitting unit provided on the throwing board. The display screen is electrically connected to the counter and displays a score calculated by the counter. The light-emitting unit indicates a position of the throwing hole.

### CROSS-REFERENCE TO RELATED APPLICATIONS

This application claims the priority of Chinese Patent Application No. 202520175258.9, filed on Jan. 26, 2025, the entire content of which is hereby incorporated by reference.

### FIELD OF TECHNOLOGY

The present application relates to the technical field of leisure equipment, and in particular to a sandbag throwing device.

### BACKGROUND

As a traditional sports game, sandbag throwing can not only exercise a user's muscle strength and hand-eye coordination ability, but also cultivate agile reaction ability in entertainment. It is a throwing sport that people often play, and is especially popular among children and teenagers. Equipment used for the sandbag throwing includes a sandbag and a throwing board. The throwing board is usually made of a straight wooden board with a throwing hole, but its structure is relatively simple and can only meet basic throwing needs, but it cannot record the number of sandbags thrown.

In a process of using a throwing board for sandbag throwing competition or training, a thrower needs to throw at a certain distance from the throwing board, and a third person or opponent standing near the throwing board is responsible for recording a score. However, this method lacks an instant score feedback mechanism. The thrower is sometimes unable to confirm whether he has scored or not due to being too far away from the throwing board, and whether the opponent has accurately recorded the score, which directly leads to the thrower's questioning of the fairness of the competition results. At the same time, since both parties cannot understand each other's scores in real time, tactical adjustments become difficult, reducing strategy and interactivity of the competition. In addition, in a dimly lit environment, it is difficult for the user to accurately judge whether the sandbag has been thrown into the throwing hole, because whether the sandbag is thrown in or not, it will eventually fall to the ground. Lack of a clear instruction and feedback not only affects smoothness and fun of the competition, but also leads to unfair competition results due to misjudgment and even cause controversy.

### SUMMARY

Based on this, a purpose of this application is to provide a sandbag throwing device to improve fairness, strategy and interactivity of a sandbag throwing competition.

This application may be implemented through the following technical solution:
a sandbag throwing device, including: a throwing board with a throwing hole;
a counter, a display screen and a light-emitting unit provided on the throwing board; wherein the display screen is electrically connected to the counter and displays a score calculated by the counter; the light-emitting unit indicates a position of the throwing hole.

Compared with prior arts, this application provides the counter and the display screen on the throwing board, so that a thrower may observe score changes through the display screen, evaluate and adjust his throwing skills and strategies. Secondly, by providing the light-emitting unit to indicate the position of the throwing hole, visibility of the throwing board at night or in a dim environment is improved.

### BRIEF DESCRIPTION

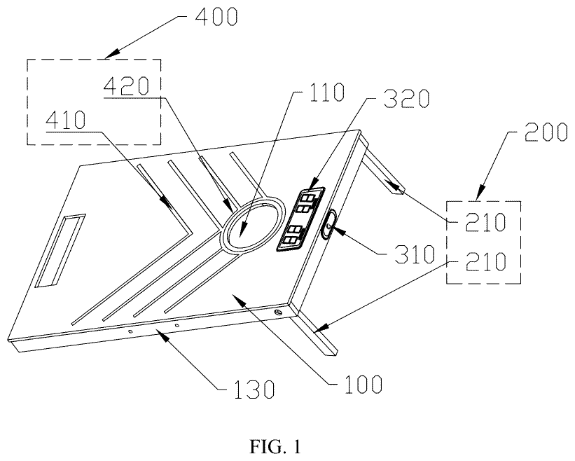

FIG. 1 is a schematic structural diagram of a sandbag throwing device according to embodiment 1 of the present application;

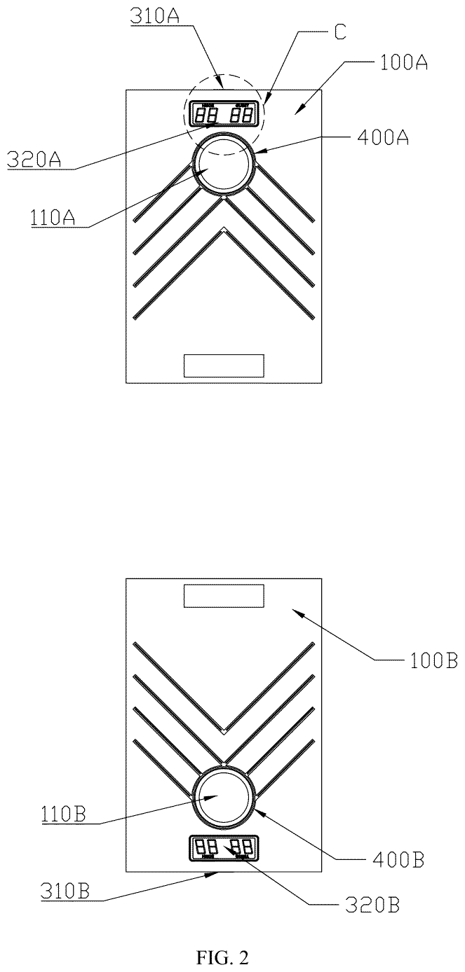

FIG. 2 is a schematic structural diagram of a sandbag throwing device according to embodiment 2 of the present application;

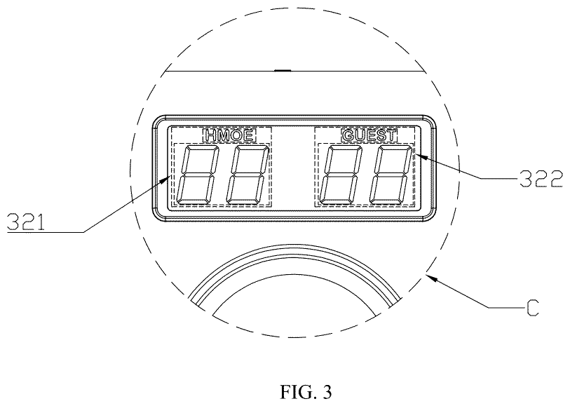

FIG. 3 is a partial enlarged diagram of FIG. 2;

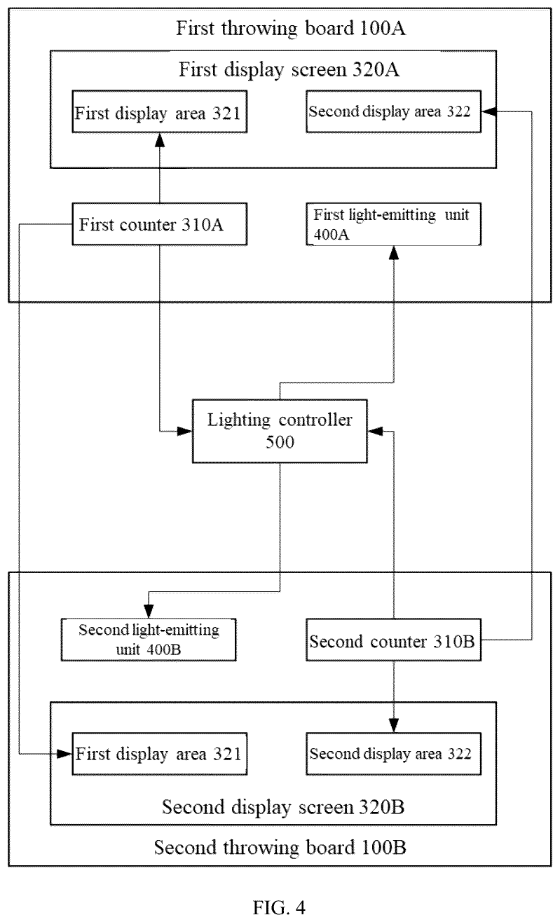

FIG. 4 is a schematic diagram of a connection between a first throwing board and a second throwing board of FIG. 2;

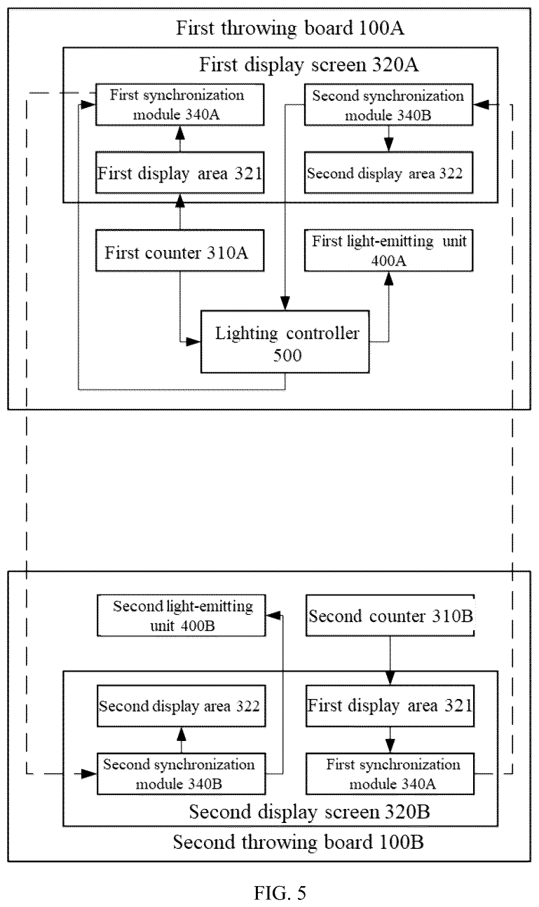

FIG. 5 is a schematic diagram of a sandbag throwing device according to embodiment 3 of the present application; and

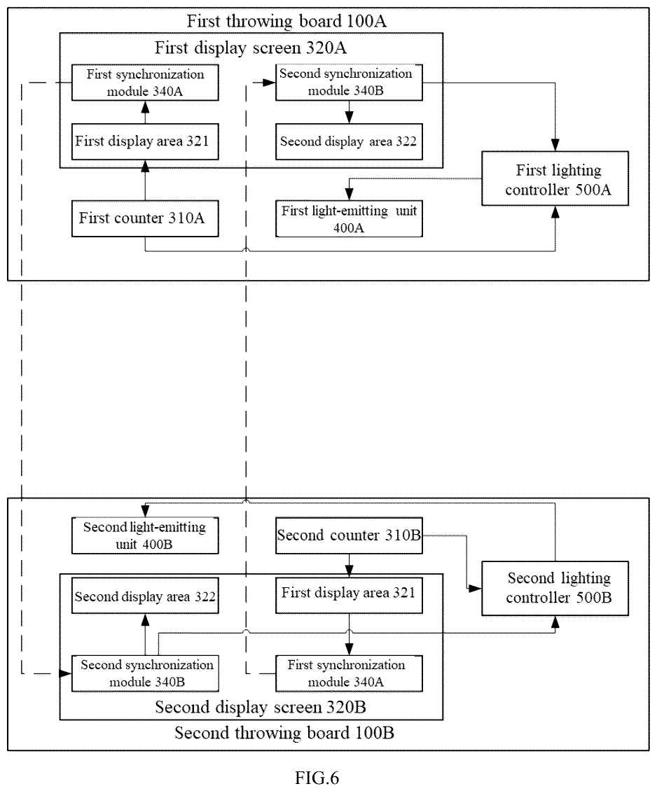

FIG. 6 is a schematic diagram of a sandbag throwing device according to embodiment 4 of the present application.

The technical solution of the present application is described in detail below in conjunction with accompanying drawings.

### DETAILED DESCRIPTION

### Embodiment 1

With reference to FIG. 1, this embodiment provides a sandbag throwing device, including a throwing board 100; and a counter 310, a display screen 320 and a light-emitting unit 400 disposed on the throwing board 100. The throwing board 100 is provided with a throwing hole 110. The display screen 320 is electrically connected to the counter 310 and displays a score calculated by the counter 310. The light-emitting unit 400 indicates a position of the throwing hole 110.

In an embodiment, the counter 310 is a key-operated mechanical counter. In this case, a person needs to manually press the counter 310 to count a number of times a sandbag passes through the throwing hole 110.

In an embodiment, the counter 310 is a sensor counter, which includes a transmitting end and a receiving end disposed on opposite sides of the throwing hole. The receiving end continuously receives a signal emitted by the transmitting end. When the sandbag passes through the throwing hole, the signal received by the receiving end is momentarily interrupted, indicating a successful hit and triggering a counting process. The sensor counter may be an infrared sensor counter, a laser sensor counter, a photoelectric sensor counter, or an ultrasonic sensor counter, among others. To achieve more accurate counting, at least two sensor counters may be arranged at the throwing hole 110 to form a cross-detection area, thereby reducing likelihood of misjudgment.

In an embodiment, the counter 310 is a vibration counter, which may be disposed at any position on the throwing board 100. The vibration counter calculates a score by sensing vibrations generated when the throwing board is hit by the sandbag.

The light-emitting unit 400 may include a light ring 410 and/or at least two light strips 420, which may protrude from a surface of the throwing board or be embedded within the throwing board. The light ring 410 is arranged around the throwing hole 110. The at least two light strips 420 are disposed on both sides or below the throwing hole, forming an arrow shape pointing towards the throwing hole 110 between the two light strips 420. For example, in this embodiment, four groups of light strips which form the arrow shape are symmetrically arranged on both sides of the throwing hole. The light ring 410 and the light strips 420 make the position of the throwing hole 110 more prominent. Preferably, the light ring 410 and the light strips 420 may each include at least two colors of LED light beads. By combining LED light beads of different colors, lights of different colors or different light flicker variation forms may be created to enrich indication forms.

In some embodiments, the throwing board 100 is provided with a lighting controller, which is electrically connected to the counter 310 and the light-emitting unit 400. The lighting controller is configured to control the light-emitting unit 400 to perform a change in light color and/or alight flicker variation, based on a signal from the counter 310, thereby alerting a thrower that the sandbag has passed through the throwing hole 110 or hit the throwing board 100.

A frame 130 and a support portion 200 are further provided below the throwing board 100. The support portion 200 includes two legs. One end of each leg is rotatably connected to the frame 130, and a rotation range of the each leg is greater than 90°. Rotation of the support portion 200 allows the throwing board 100 to be in an inclined or horizontal state. The throwing board 100, the frame 130, and/or ends of the legs that contact the ground are provided with several anti-slip strips made of rubber. These anti-slip strips enhance stability of the throwing board on the ground and prevent the throwing board from moving due to impact between the sandbag and the throwing board.

In some embodiments, the support portion 200 further includes a foldable linkage. One end of the foldable linkage is rotatably connected to an outer wall of the leg 210, and the other end is rotatably connected to the throwing board 100. When the foldable linkage is in an unfolded position, it supports the leg 210 and the throwing board 100, increasing the stability of the entire throwing device.

In this embodiment, the throwing board 100 is a rectangular wooden flat board. A layer of transparent PVC material is attached to an upper surface of the throwing board 100 to protect the throwing board 100 while retaining wooden texture. In other embodiments, shape and material of the throwing board 100 may be adjusted according to specific requirements. For example, the material of the throwing board 100 may be made of plastic, and the shape of the throwing board 100 may be triangular or other geometries.

To reduce volume of the throwing board 100 for easier storage, the throwing board 100 may be designed as a foldable structure which includes a first panel and a second panel with a smaller area. The throwing hole 110 is provided on the first panel, and the second panel is hinged to the first panel, so that the second panel may be rotated to overlap with the first panel for convenient carrying and storage. Preferably, handles are provided on respective sides of the first panel and the second panel to facilitate carrying the throwing board 100. More preferably, a storage bag for sandbags is provided below the second panel.

The throwing board is further provided with a power supply portion, the power supply portion may include a battery, a switching power supply or other devices that are capable of outputting a stable voltage signal. The power supply portion is electrically connected to the counter 310, the display screen 320, and/or the light-emitting unit 400 to supply power to the counter 310, the display screen 320, and/or the light-emitting unit 400. The power supply portion is provided with a charging port, and a user may charge the power supply portion through the charging port. In some embodiments, the power supply portion is disposed within a shock-absorbing compartment to mitigate vibration effects on the power supply portion caused by the sandbag hitting the throwing board 100.

In some embodiments, the sandbag throwing device further includes a speaker linked to the counter. The speaker may announce the score from the counter in real time. Preferably, volume and announcement language of the speaker may be adjusted. Additionally, a timer may be provided on the throwing board to enrich gameplay rules or usage scenarios of the sandbag throwing device.

This embodiment enables the thrower to observe score changes via the display screen, to evaluate and adjust their throwing techniques and strategies, by providing the counter and the display screen on the throwing board. Furthermore, by providing the light ring and light strips to indicate the position of the throwing hole, visibility of the throwing board at night or in a dim environment is improved. Moreover, by using the sensor counter or the vibration counter, automatic scoring may be achieved to avoid manual scoring errors or time waste, thereby enhancing throwing experience. Additionally, by providing the timer to time a game or training, practicality and user experience of the sandbag throwing device are further improved.

### Embodiment 2

A sandbag throwing device of Embodiment 2 is designed for a competitive scenario involving two teams, and the sandbag throwing device includes two throwing boards that may automatically and instantly display throwing scores of both sides.

Specifically, referring to FIGS. 2-4, the sandbag throwing device of this embodiment includes a first throwing board 100A, a second throwing board 100B, and a lighting controller 500. In a head-to-head competition, the first throwing board 100A and the second throwing board 100B are positioned at a certain distance from each other. Contestant A (the away team), standing on a side of the first throwing board 100A, throws the sandbag toward the second throwing board 100B. Contestant B (the home team), standing on a side of the second throwing board 100B, throws the sandbag toward the first throwing board 100A.

The first throwing board 100A is provided with a first throwing hole 110A, a first counter 310A, a first display screen 320A, and a first light-emitting unit 400A. The second throwing board 100B is provided with a second throwing hole 110B, a second counter 310B, a second display screen 320B, and a second light-emitting unit 400B. Structures of the first throwing board 100A and the second throwing board 100B are the same as that described in Embodiment 1 and will not be repeated here.

Different from Embodiment 1, the first display screen 320A and the second display screen 320B are both respectively provided with a first display area 321 and a second display area 322. The first display area 321 of the first display screen 320A and the first display area 321 of the second display screen 320B are both electrically connected to the first counter 310A to display a score of the first counter 310A, i.e., a score of contestant B. The second display area 322 of the first display screen 320A and the second display area 322 of the second display screen 320B are both electrically connected to the second counter 310B to display a score of the second counter 310B, i.e., a score of contestant A. Additionally, the first display area 321 may further display name information for contestant B, while the second display area 322 may display name information for contestant A.

The lighting controller 500 is electrically connected to the first counter 310A and the second counter 310B respectively. Based on a signal of a counting result of the first counter 310A and a signal of a counting result of the second counter 310B, the lighting controller 500 controls a change in light color and/or a light flicker variation of the first light-emitting unit 400A and the second light-emitting unit 400B respectively.

In an embodiment, when count of the first counter 310A increases, that is contestant B scores, the lighting controller 500 immediately controls both the first light-emitting unit 400A and the second light-emitting unit 400B to simultaneously display a first light color, such as a red light, and/or a light flicker variation. When count of the second counter 310B increases, that is contestant A scores, the lighting controller 500 immediately controls both the first light-emitting unit 400A and the second light-emitting unit 400B to simultaneously display a second light color, such as a green light, and/or a light flicker variation. In this way, two opponents may visually and quickly determine whether the two opponents have scored based on lighting changes.

In another embodiment, the lighting controller 500 receives signals from the first counter 310A and the second counter 310B and compares the score calculated by the first counter 310A and the score calculated by the second counter 310B. Based on a comparison result, the lighting controller 500 synchronously controls the first light-emitting unit 400A and the second light-emitting unit 400B to indicate different light colors and/or light flicker variations. For example, when the score calculated by the first counter 310A is greater than the score calculated by the second counter 310B, that is contestant B is ahead, the lighting controller 500 controls both the first light-emitting unit 400A and the second light-emitting unit 400B to simultaneously display the first light color, such as a red light, and/or a high-frequency flickering light. When the score calculated by the first counter 310A is less than the score calculated by the second counter 310B, that is contestant A is ahead, the lighting controller 500 controls both the first light-emitting unit 400A and the second light-emitting unit 400B to simultaneously display the second light color, such as a green light, and/or a low-frequency flickering light. When the score calculated by the first counter 310A is equal to the score calculated by the second counter 310B, the lighting controller 500 controls both the first light-emitting unit 400A and the second light-emitting unit 400B to simultaneously display the third light color, such as a blue light, and/or a steady-on light. In this way, the two opponents may visually and quickly understand comparative results of the competition through the lighting changes.

Since two opponents may only see a lighting indication on an opposing throwing board, in an embodiment, the lighting controller 500 receives the signal from the first counter 310A and the signal from the second counter 310B, compares the score calculated by the first counter 310A and the score calculated by the second counter 310B, and then controls the first light-emitting unit 400A and the second light-emitting unit 400B to display different light colors and/or light flicker variations respectively. For example, when the score calculated by the first counter 310A is greater than the score calculated by the second counter 310B, the lighting controller 500 controls the first light-emitting unit 400A to display the first light color, such as the red light, and simultaneously controls the second light-emitting unit 400B to display the second light color, such as the green light. At this time, contestant B sees the red light displayed on the first light-emitting unit 400A and knows that his score is leading, while contestant A sees the green light displayed on the second light-emitting unit 400B and knows that his score is lagging behind. When the score calculated by the first counter 310A is less than the score calculated by the second counter 310B, the lighting controller 500 controls the first light-emitting unit 400A to display the second light color, such as the green light, and simultaneously controls the second light-emitting unit 400B to display the first light color, such as the red light. At this time, contestant B sees the green light displayed on the first light-emitting unit 400A and knows that his score is lagging behind, while contestant A sees the red light displayed on the second light-emitting unit 400B and knows that his score is leading. When the score calculated by the first counter 310A is equal to the score calculated by the second counter 310B, the lighting controller 500 controls both the first light-emitting unit 400A and the second light-emitting unit 400B to simultaneously display the third light color, such as the blue light. At this time, both contestant A and contestant B see the blue light and know that the scores are tied.

In some embodiments, above lighting control modes may be combined and alternately displayed.

The above mentioned various lighting control modes may be pre-set in the lighting controller 500, so that the user may select a lighting indication mode based on their preferences or competition needs.

By observing changes in lights of the light-emitting units, the user may immediately understand competition status, such as whether a score has been made, which side is leading, etc., enabling them to make more informed strategic decisions to counter their opponent. This enhances real-time responsiveness and interactivity of a game, while simultaneously improves visual spectacle and competitive intensity of the game. Additionally, by setting the counter and the display screen to accurately record and instantly display the scores of both contestants, the user may clearly understand the score situation, enhancing fairness and transparency of the game while reducing disputes and disagreements.

### Embodiment 3

In the Embodiment 2 described above, since the first counter 310A disposed on the first throwing board 100A and the second counter 310B disposed on the second throwing board 100B both require wired electrical connections respectively to their respective display screen-the first display screen 320A disposed on the first throwing board 100A and the second display screen 320B disposed on the second throwing board 100B, this results in complex wiring configurations with exposed wiring segments over extended distances during operation, leading to user inconvenience and potential signal instability. Therefore, in Embodiment 3, based on Embodiment 2, a signal transmission method between a counter and a display screen is further improved. A wired connection between the first counter 310A disposed on the first throwing board 100A and the second display screen 320B disposed on the second throwing board 100B, as well as a wired connection between the second counter 310B disposed on the second throwing board 100B and the first display screen 320A disposed on the first throwing board 100A, are replaced with wireless communication to address issues caused by long-distance wired connections.

Specifically, referring to FIGS. 2 and 5, in this Embodiment 3, on a first throwing board 100A of a sandbag throwing device, the first display area 321 of the first display screen 320A is electrically connected to the first counter 310A to display the score calculated by the first counter 310A, with a first synchronization module 340A electrically connected thereto provided in the first display area 321 of the first display screen 320A. On the second throwing board 100B, the first display area 321 of the second display screen 320B is electrically connected to the second counter 310B to display the score calculated by the second counter 310B, with a first synchronization module 340A electrically connected thereto also provided in the first display area 321 of the second display screen 320B.

That is, each first display area 321 is provided with one first synchronization module 340A, and each second display area 322 is provided with one second synchronization module 340B. In this way, the second display area 322 of the first throwing board 100A, via wireless communication between the second synchronization module 340B disposed on the first throwing board 100A and the first synchronization module 340A disposed on the second throwing board 100B, displays the score from the first display area 321 of the second throwing board 100B—specifically the score calculated by the second counter 310B representing Contestant B's performance—on the second display area 322 of the first throwing board 100A. Similarly, the second display area 322 of the second throwing board 100B, via wireless communication between the second synchronization module 340B disposed on the second throwing board 100B and the first synchronization module 340A disposed on the first throwing board 100A, displays the score from the first display area 321 of the first throwing board 100A—specifically the score calculated by the first counter 310A representing Contestant A's performance—on the second display area 322 of the second throwing board 100B.

Further, the second synchronization module 340B on one throwing board and corresponding first synchronization module 340A on the other throwing board may employ wireless communication methods including but not limited to: Bluetooth mesh wireless communication, radio-frequency (RF) wireless communication, a 2.4 GHz wireless module communication, or 2.4 GHz RF wireless communication.

The lighting controller 500 is electrically connected to both the counter and the second synchronization module 340B disposed on one throwing board. Based on a count signal from the counter and the second synchronization module 340B disposed on the one throwing board, the lighting controller 500 synchronously controls the light color and/or light flicker variation of the light-emitting units disposed on the two throwing boards, respectively. For example, in this Embodiment 3, the lighting controller 500 is disposed on the first throwing board 100A and is electrically connected to the first light-emitting unit 400A, the first counter 310A, the first synchronization module 340A, and the second synchronization module 340B disposed on the first throwing board 100A. The second light-emitting unit 400B is electrically connected to the second synchronization module 340B disposed on the second throwing board 100B. The lighting controller 500 receives the signal from the first counter 310A disposed on the first throwing board 100A and the signal from the second synchronization module 340B disposed on the first throwing board 100A, compares the score calculated by the first counter 310A with the score received by the second synchronization module 340B, and then controls a change in light color and/or a light flicker variation of the first light-emitting unit 400A based on a comparison result. Through wireless communication between the first synchronization module 340A disposed on the first throwing board 100A and the second synchronization module 340B disposed on the second throwing board 100B, the lighting controller 500 also synchronously controls a change in light color and/or a light flicker variation of the second light-emitting unit 400B. The light control modes of the lighting controller 500 are similar to those in Embodiment 2 and will not be repeated here.

In embodiment 3, implementation of wireless communication-enabled synchronization modules eliminates long-distance wired connections between the two throwing boards, thereby resolving issues caused by wired connections, such as cable entanglement and susceptibility to damage inherent in exposed wiring. This configuration concurrently reduces spatial footprint of the sandbag throwing device during storage while enhancing its portability for transportation and compact storage.

### Embodiment 4

In the above-mentioned embodiment 3, since only one lighting controller 500 is provided, and the lighting controller 500 is connected by wiring to the counter 310A and the light-emitting unit 400A disposed on the first throwing board 100A, and wirelessly connected to the counter 310B and the light-emitting unit 400B disposed on the second throwing board 100B, the second throwing board 100B must be used in combination with the first throwing board 100A, and cannot be used alone or in combination with other second throwing boards 100B, thereby limiting flexibility of use of the sandbag throwing device. In particular, in occasions such as stadiums where multiple groups of contestants are simultaneously participating in a throwing competition, if a group of contestants does not distinguish between the first throwing board 100A and the second throwing board 100B, and uses the two first throwing boards 100A in combination, other contestants may not be able to compete properly due to the lack of the first throwing board 100A. In addition, all control logics in Embodiment 3 are concentrated in one lighting controller 500. Once the controller fails, the entire device will not work properly, and during maintenance, the control logic of the entire device needs to be checked, resulting in high complexity and cost of maintenance. Therefore, in Embodiment 4, based on the above Embodiment 3, a control method of the lighting controller is improved, and an independent lighting controller is set on each throwing board. Each lighting controller controls a change in light color and/or a light flicker variation of a light-emitting unit disposed on the same throwing board based on signals from a counter and a second synchronization module disposed on the same throwing board, so as to solve use restrictions and maintenance problems caused by a single lighting controller.

Specifically, please referring to FIGS. 2 and 6, in the sandbag throwing device of this embodiment 4, a first lighting controller 500A is provided on the first throwing board 100A. The first lighting controller 500A is electrically connected to the first counter 310A, the second synchronization module 340B and the first light-emitting unit 400A disposed on the first throwing board 100A, and controls a change in light color and/or a light flicker variation of the first light-emitting unit 400A based on the signals of the first counter 310A and the second synchronization module 340B disposed on the first throwing board 100A. A second lighting controller 500B is provided on the second throwing board 100B. The second lighting controller 500B is electrically connected to the second counter 310B, the second synchronization module 340B and the second light-emitting unit 400B disposed on the second throwing board 100B, and controls a change in light color and/or a light flicker variation of the second light-emitting unit 400B based on the signals of the second counter 310B and the second synchronization module 340B disposed on the second throwing board 100B.

When the score calculated by the first counter 310A is greater than the score received by the second synchronization module 340B disposed on the first throwing board 100A, the first lighting controller 500A controls the first light-emitting unit 400A to display a first light color, such as a red light; at the same time, the score calculated by the second counter 310B is less than the score received by the second synchronization module 340B disposed on the second throwing board 100B, and the second lighting controller 500B controls the second light-emitting unit 400B to display a second light color, such as a green light. When the score calculated by the first counter 310A is less than the score received by the second synchronization module 340B disposed on the first throwing board 100A, the first lighting controller 500A controls the first light-emitting unit 400A to display the second light color, such as the green light; at the same time, the second lighting controller 500B controls the second light-emitting unit 400B to display the first light color, such as the red light. When the score calculated by the first counter 310A is equal to the score received by the second synchronization module 340B disposed on the first throwing board 100A, the first lighting controller 500A controls the first light-emitting unit 400A to display a third light color, such as a blue light, and at the same time, the second lighting controller 500B controls the second light-emitting unit 400B to display the third light color, such as the blue light.

In this embodiment 4, an independent lighting controller is provided on each throwing board. By pairing the synchronization modules of any two throwing boards, a free combination of the two throwing boards may be realized without distinguishing whether the throwing board is the first throwing board or the second throwing board. This configuration eliminates a need to store the two paired throwing boards together when storing, and avoids hassle of locating originally paired throwing boards during subsequent use, thereby improving convenience of use and storage flexibility of multiple sandbag throwing devices. In addition, since each lighting controller works independently, failure of a single controller will not cause failure of the entire device, thereby improving fault tolerance and replaceability of the device and reducing difficulty and cost of maintenance.

The present application is not limited to the above-mentioned embodiments. If various changes or modifications to the present application do not depart from spirit and scope of the present application, and if these changes and modifications fall within the claims and equivalent technical scope of the present application, the present application is also intended to include these changes and modifications.

What is claimed:

1. A sandbag throwing device, comprising:
a throwing board provided with a throwing hole,
a counter, a display screen and a light-emitting unit provided on the throwing board; wherein the display screen is electrically connected to the counter and displays a score calculated by the counter; and the light-emitting unit indicates a position of the throwing hole.

2. The sandbag throwing device of claim 1, wherein the sandbag throwing device includes two throwing boards, each of which is respectively provided with one counter, one display screen and one light-emitting unit; each display screen is provided with a first display area and a second display area, wherein the first display area is electrically connected to one counter to display a score calculated by the counter, and the second display area is electrically connected to the other counter to display a score calculated by the other counter.

3. The sandbag throwing device of claim 1, wherein the sandbag throwing device includes two throwing boards, each of which is respectively provided with one counter, one display screen and one light-emitting unit; each display screen is provided with a first display area and a second display area, wherein the first display area is electrically connected to the counter disposed on the same throwing board, to display a score calculated by the counter;
the first display area of each display screen is provided with a first synchronization module, and the second display area is provided with a second synchronization module; the second display area of each throwing board displays a score of the first display area of the other throwing board, via wireless communication between the second synchronization module of the each throwing board and the first synchronization module of the other throwing board.

4. The sandbag throwing device of claim 3, wherein the first synchronization module on each throwing board and the second synchronization module on the other throwing board are configured to communicate with each other via Bluetooth mesh communication, radio-frequency communication, 2.4 GHz wireless module communication, or 2.4 GHz wireless radio-frequency communication.

5. The sandbag throwing device of claim 3, wherein the counter is a key-operated mechanical counter.

6. The sandbag throwing device of claim 3, wherein the counter is a sensor counter.

7. The sandbag throwing device of claim 6, wherein the sensor counter is an infrared sensor counter, a laser sensor counter, a photoelectric sensor counter, or an ultrasonic sensor counter.

8. The sandbag throwing device of claim 3, wherein each light-emitting unit includes one light ring and at least two light strips, the light ring is arranged around the throwing hole; the at least two light strips are embedded in a surface of the throwing board, and an arrow shape pointing to the throwing hole is formed between the at least two light strips.

9. The sandbag throwing device of claim 3, wherein each throwing board is further provided with a lighting controller, the lighting controller configured to control a change in light color and/or a light flicker variation of the light-emitting unit disposed on the same throwing board, based on signals from the counter and the second synchronization module both disposed on the same throwing board.

10. The sandbag throwing device of claim 9, wherein:
when a score calculated by the counter is greater than a score received by the second synchronization module, the lighting controller controls the light-emitting unit to display a first light color and/or a first light flicker variation;
when the score calculated by the counter is less than the score received by the second synchronization module, the lighting controller controls the light-emitting unit to display a second light color and/or a second light flicker variation; and
when the score calculated by the counter is equal to the score received by the second synchronization module, the lighting controller controls the light-emitting unit to display a third light color and/or a third light flicker variation.

11. The sandbag throwing device of claim 3, further comprising a lighting controller, wherein the lighting controller is configured to synchronously control a change in light color and/or alight flicker variation of the light-emitting unit disposed on the two throwing boards, based on signals from the counter and the second synchronization module disposed on one of the two throwing boards.

12. The sandbag throwing device of claim 11, wherein:
when a score calculated by the counter is greater than a score received by the second synchronization module, the lighting controller respectively controls the light-emitting unit disposed on the two throwing boards to synchronously display a first light color and/or a first light flicker variation;
when the score calculated by the counter is less than the score received by the second synchronization module, the lighting controller respectively controls the light-emitting unit disposed on the two throwing boards to synchronously display a second light color and/or a second light flicker variation; and
when the score calculated by the counter is equal to the score received by the second synchronization module, the lighting controller respectively controls the light-emitting unit disposed on the two throwing boards to synchronously display a third light color and/or a third light flicker variation.

13. The sandbag throwing device of claim 2, further comprising a lighting controller, wherein the lighting controller is configured to respectively control a change in light color and/or alight flicker variation of the light-emitting unit disposed on the two throwing boards, based on signals from the counter disposed on the two throwing boards.

14. The sandbag throwing device of claim 13, wherein:
when a score calculated by the counter disposed on one throwing board is greater than a score calculated by the counter disposed on the other throwing board, the lighting controller controls the light-emitting unit to display a first light color and/or a first light flicker variation;
when the score calculated by the counter disposed on the one throwing board is less than the score calculated by the counter disposed on the other throwing board, the lighting controller controls the light-emitting unit to display a second light color and/or a second light flicker variation; and
when the score calculated by the counter disposed on the one throwing board is equal to the score calculated by the counter disposed on the other throwing board, the lighting controller controls the light-emitting unit to display a third light color and/or a third light flicker variation.

15. The sandbag throwing device of claim 1, wherein a support portion is provided below the throwing board, and rotation of the support portion causes the throwing board to be in an inclined state or to return to a horizontal state.

16. The sandbag throwing device of claim 15, wherein the support portion includes two legs, the legs are rotatably connected to the throwing board, and a rotation range of the legs is greater than 90°.
